(19) United States
(12) Patent Application Publication
(10) Pub. No.: US 2009/0278801 A1
(43) Pub. Date: Nov. 12, 2009

(54) Method For Executing Command Associated With Mouse Gesture

(76) Inventor: Kuo-Shu Cheng, Hsin-Dian City (TW)

Correspondence Address: LIN & ASSOCIATES INTELLECTUAL PROPERTY, INC., P.O. BOX 2339, SARATOGA, CA, 95070-0339, US

(21) Appl. No.: 12/118,728

(22) Filed: May 11, 2008

(51) Int. Cl. G06F 3/033

(52) U.S. Cl. 345/163

(57) ABSTRACT

A method for executing a predetermined command associated with a mouse gesture includes the steps of: (1) recording a motion track of the mouse; (2) calculating a distance of the motion track of the mouse; if the distance is less than a predetermined value, returning to step (1); (3) transforming the motion track from rectangular coordinates to polar coordinates represented by a distance and an angle, in which the polar coordinate system is divided into eight angle regions, determining which angle region the angle of the polar coordinates is located in, and executing a predetermined command corresponding to the region in which the angle is located, wherein the eight regions are defined as N×45°±22.5°, and N is one of integers 0, 1, 2, 3, 4, 5, 6, and 7; (4) clearing the recorded mouse motion track, or subtracting the predetermined value from the recorded mouse motion track, and returning to step (1).

### BACKGROUND OF THE INVENTION

1. Field of the Invention

The present invention relates generally to a method for mouse gesture, and more particularly, to a method for executing a predetermined command associated with a mouse gesture presented by a user in operating a mouse.

2. The Prior Arts

Recently, as an enhancement capability of a mouse, mouse gesture function has been more and more widely provided in web browsers for improving the efficiency and performance thereof, and even supports other software in a computer. For example, Strokelt mouse gesture software, Avantfind mouse gesture add-on, Opera mouse gesture software, Firefox mouse gesture add-on, and Tencent Traveler TT mouse gesture software all provide a mouse gesture support function. A typical mouse gesture is generally operated as following: holding down a mouse button (usually the right button); dragging the mouse in a certain motion track to form a mouse gesture; then releasing the mouse button; and the software recognizing the mouse gesture and executing a command corresponding to the mouse gesture.

China Patent Publication No. CN1790262A discloses a method for controlling an operation of computer software according to a mouse motion track. The method includes the following steps. A mouse motion sub-program is activated. The mouse motion sub-program captures and records a motion track of a mouse until the mouse stops moving. Then, the mouse motion sub-program compares the recorded motion track with motion tracks stored in a database. If the recorded motion track matches with one of the stored motion tracks in the database, the mouse motion sub-program transmits an instruction to a main program to execute a command corresponding to the matched motion track. If the recorded motion track does not match with any motion track in the database, the foregoing steps of capturing, recording, and comparing are repeated until the mouse motion sub-program is stopped.

However, being restricted by the pointer precision of the mouse, and the recognition accuracy of the mouse motion track, the configurations of the conventional mouse gestures are still pretty simple. Moreover, each of the conventional mouse gestures corresponds to only one command. As such, it is difficult to expand the applications of the mouse gestures.

### SUMMARY OF THE INVENTION

A primary objective of the present invention is to provide a method for executing a predetermined command associated with a mouse gesture in a consecutive operation mode. In the consecutive operation mode, the predetermined command is executed right after a portion of the mouse gesture is recognized. The predetermined commands are consecutively executed during the mouse gesture being recognized.

Another objective of the present invention is to provide a method for executing a predetermined command associated with a mouse gesture in an inconsecutive operation mode. In the inconsecutive operation mode, the predetermined commands are not executed until the whole mouse gesture is recognized.

For achieving the primary objective of the present invention, the method according to the present invention includes the steps of:

(1) recording a motion track of the mouse;

(2) calculating a distance of the motion track of the mouse; if the distance is less than a predetermined value, returning to step (1);

(3) transforming the motion track from rectangular coordinates to polar coordinates represented by a distance and an angle, in which the polar coordinate system is divided into eight angle regions, determining which angle region the angle of the polar coordinates is located in, and executing a predetermined command corresponding to the angle region in which the angle is located, wherein the eight angle regions are defined as N×45°±22.5°, and N is one of integers 0, 1, 2, 3, 4, 5, 6, and 7; and

(4) clearing the recorded motion track or subtracting the predetermined value from the recorded motion track, and returning to the step (1).

Further, a triggering module can be used to start or stop the aforementioned steps. The triggering module may include a predetermined button of a mouse, a predetermined key of a keyboard, a plurality of the predetermined buttons, a plurality of the predetermined keys, or a combination of at least one predetermined button and one predetermined key.

In order to achieve the another objective of the present invention, the method according to the present invention includes the steps of:

(1) if a predetermined button is pressed down, performing steps (2) through

(4); otherwise going to step (5);

(2) recording a motion track of the mouse;

(3) calculating a distance of the motion track of the mouse; if the distance is less than a predetermined value, returning to step (1);

(4) transforming the motion track from rectangular coordinates to polar coordinates represented by a distance and an angle, in which the polar coordinate system is divided into eight angle regions, determining which angle region the angle of the polar coordinates is located in, storing a number representing the angle region in which the angle is located into a sequential buffer, subtracting the predetermined value from the recorded mouse motion track, and returning to step (1); in which the eight regions are defined as N×45°±22.5°, and N is one of integers 0, 1, 2, 3, 4, 5, 6, and 7;

(5) executing at least one corresponding predetermined command according to a content of the sequential buffer; and

(6) clearing the recorded mouse motion track and the sequential buffer, and returning to step (1).

The present invention defines the mouse motion track in a polar coordinate system. According to the present invention, the mouse motion track can be a single line or at least two connection lines sequentially connected together. The single line includes a start point and an end point, and the angle of the single line is regarded as an integral multiple of 45°. When the mouse motion track is composed of at least two connection lines, each of the connection lines includes a start point and an end point, and the end point of the former connection line is overlapped with the start point of the latter connection line connected thereto. Each of the angles of the connection lines is regarded as an integral multiple of 45°.

Referring to FIG. 4, when the mouse motion track is a single line, the single line may be featured as one of ↑, ↓, ←, →, □, □, □, and □, each of which including a terminal with an arrowhead and the other terminal without the arrowhead. The terminal without the arrowhead represents a beginning point of the motion track, and the terminal with the arrowhead represents a finish point of the motion track. Further the single line may include two lines going forth and back. The single line including two lines going forth and back looks like an eraser moving forth and back to remove marks made with pens, pencils, etc. Therefore, the single line including two lines going forth and back may correspond to but not limited to an erasing function.

When the mouse motion track is composed of a first connection line and a second connection line, an angle between the first connection line and the second connection line may be regarded as 45°, 90°, 135° or 180°. The mouse motion tracks may be featured as but not limited to the ones shown in FIG. 5. When the angle between the two connection lines is 90°, the first connection line and the second connection line as a whole may be featured as one of [symbol] and [symbol] . The end point of the second connection line represents a finish point of the motion track, and the start point of the first connection line represents a beginning point of the motion track. Further, any of the connection lines may include two lines going forth and back.

According to the present invention, a mouse motion track composed of a first connection line, a second connection line, and a third connection line connected in sequence may be featured as but not limited to the ones shown in FIG. 6. Each of the first connection line, the second connection line, and the third connection line includes a start point and an end point. The end point of the third connection line represents a finish point of the motion track, and the start point of the first connection line represents a beginning point of the motion track.

Lengths of the single line and connection lines mentioned above are adjustable. In other words, the mouse gestures can be personalized. The user can respectively set up the lengths of the aforementioned single line or connection lines to predetermined values in accordance with personal preference.

The above characteristics and the steps are executable within a program module. The program module may be installed in a mouse or a computer.

The present invention introduces a polar coordinate system for recognizing the mouse motion track, which greatly improves the recognition accuracy. Thus, the present invention allows a user to consecutively or inconsecutively execute at least one corresponding predetermined command in accordance with a mouse gesture presented by the user in operating a mouse.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a schematic diagram illustrating a polar coordinate system partitioned into eight polar angle regions according to the present invention;

FIG. 2 is a flow chart illustrating a consecutive operation mode according to a first embodiment of the present invention;

FIG. 3 is a flow chart illustrating an inconsecutive operation mode according to a second embodiment of the present invention;

FIG. 4 is a schematic diagram illustrating that the mouse motion track is a single line;

FIG. 5 is a schematic diagram illustrating that the mouse motion track is composed of two connection lines sequentially connected together; and

FIG. 6 is a schematic diagram illustrating that the mouse motion track is composed of three connection lines sequentially connected together.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

Prior to detailed description of the preferred embodiments, the present invention defines features of a mouse gesture, i.e., a mouse motion track, which is addressed as following.

1. The mouse gestures are defined in a polar coordinate system; and

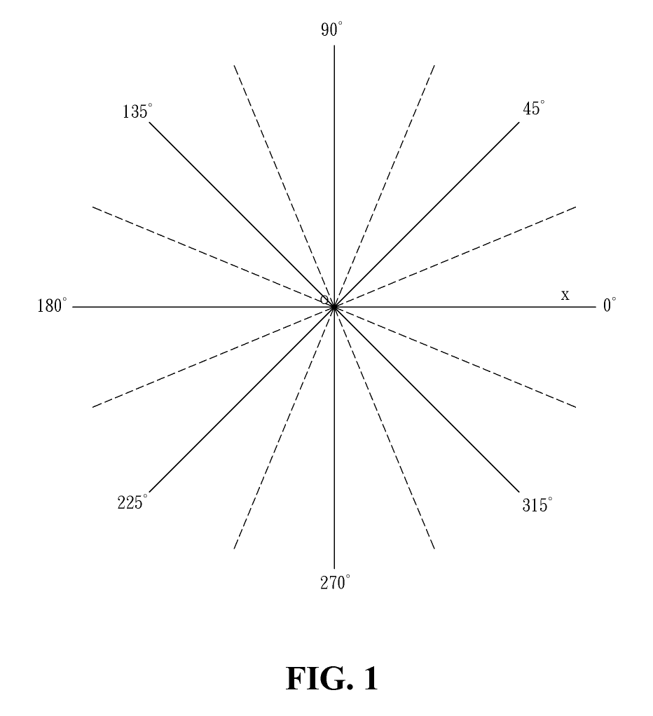

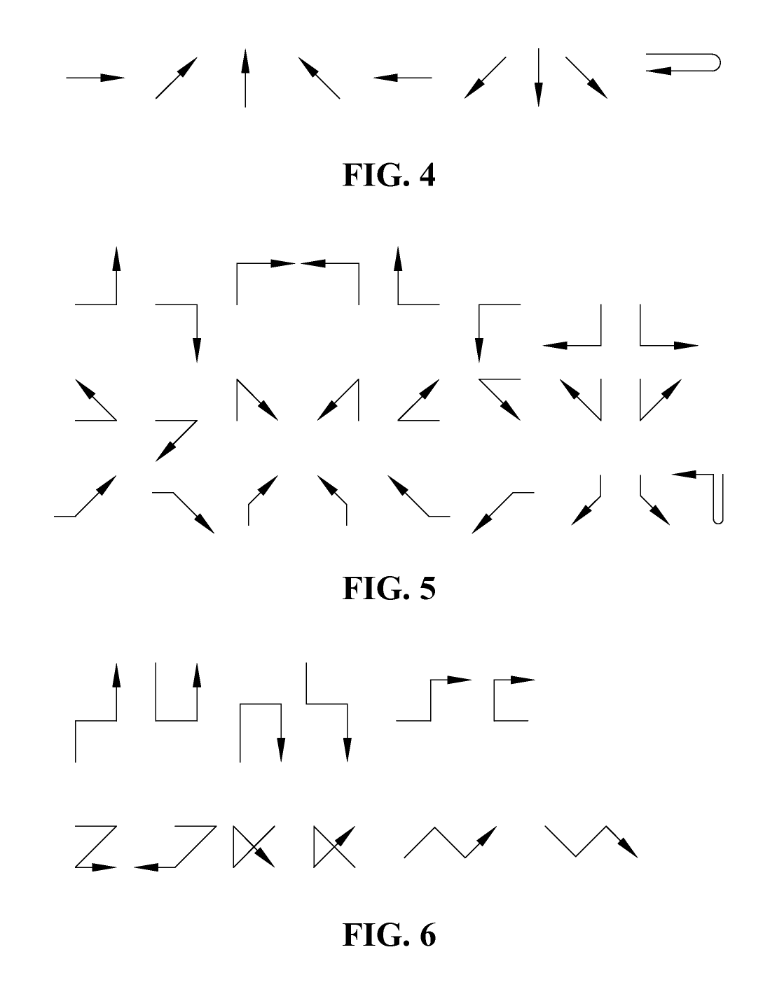

2. The mouse motion track is composed of a single line as shown in FIG. 4, two connection lines sequentially connected together as shown in FIG. 5, or three connection lines sequentially connected together as shown in FIG. 6. The mouse motion tracks includes but not limited to the mouse motion tracks shown in FIGS. 4, 5 and 6. Referring to FIG. 4, the single line includes a start point and an end point, and an angle of the single line is regarded as an integral multiple of 45°. Referring to FIGS. 5 and 6, each of the connection lines includes a start point and an end point, and each of angles of the connection lines is regarded as an integral multiple of 45°. The end point of the former connection line is overlapped with the start point of the latter connection line sequentially connected thereto. The start point of the first connection line is a beginning point of the mouse motion track and the end point of the last connection line is a finish point of the mouse motion track. It is unlikely that the user drags the mouse to have a mouse motion track in a perfect form. Instead of being perfectly straight, the single line and the connection lines are more likely to be curved or irregular. Each of the angles of the single line and the connection lines is unlikely to be an exact integral multiple of 45°. The solution of the present invention is to partition a polar coordinate system into eight angle regions as shown in FIG. 1. When recognizing the mouse motion track, the start point of the single line or each of the connection lines is placed on an origin of the polar coordinate system. When the single line or the connection line falls in one of the eight angle regions, it is recognized as a perfect straight line with an exact angle representing the angle region.

Referring to FIG. 1, an O-X polar coordinate system is partitioned into eight angle regions 0°, 45°, 90°, 135°, 180°, 225°, 270°, and 315°, which is defined as N×45°±22.5° and N is one of integers 0, 1, 2, 3, 4, 5, 6, and 7. Each of the eight angle regions has a range of ±22.5°. For example, the user drags the mouse rightward to form a single line with an angle of 10°. The start point of the single line is placed on the origin O of the O-X polar coordinate system, and thus the single line falls in the angle region of 0°. The motion track is regarded as a straight line having an angle of 0° instead of an irregular line having an angle of 10°. Therefore, the problem regarding deviation of the motion track in conventional methods, which makes it difficult to match the recognized motion track with motion tracks stored in a database, is solved.

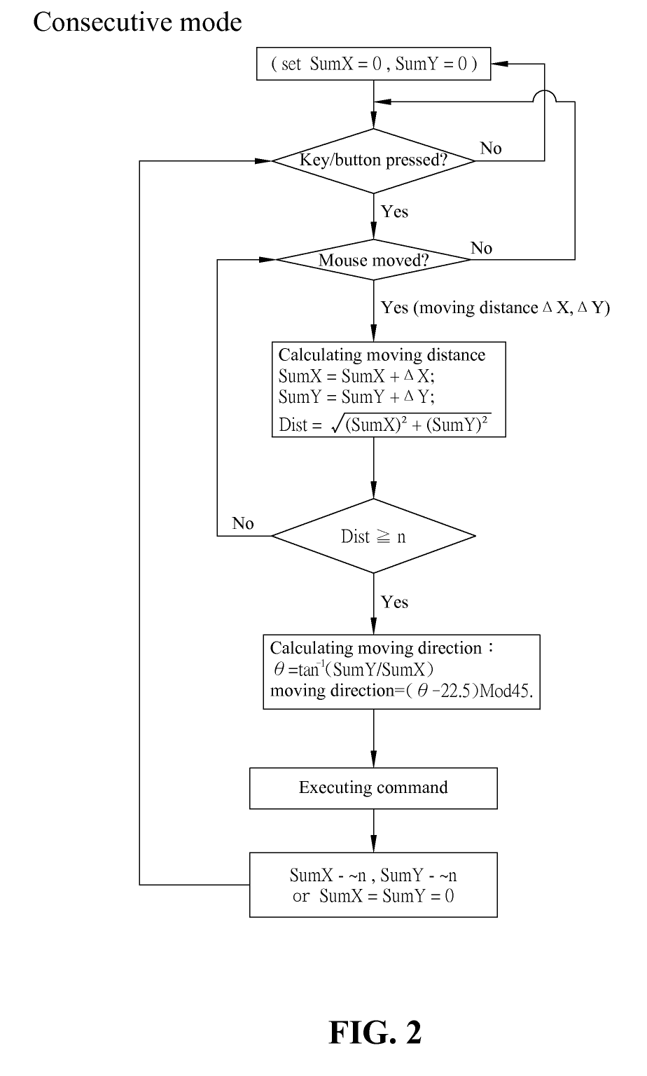

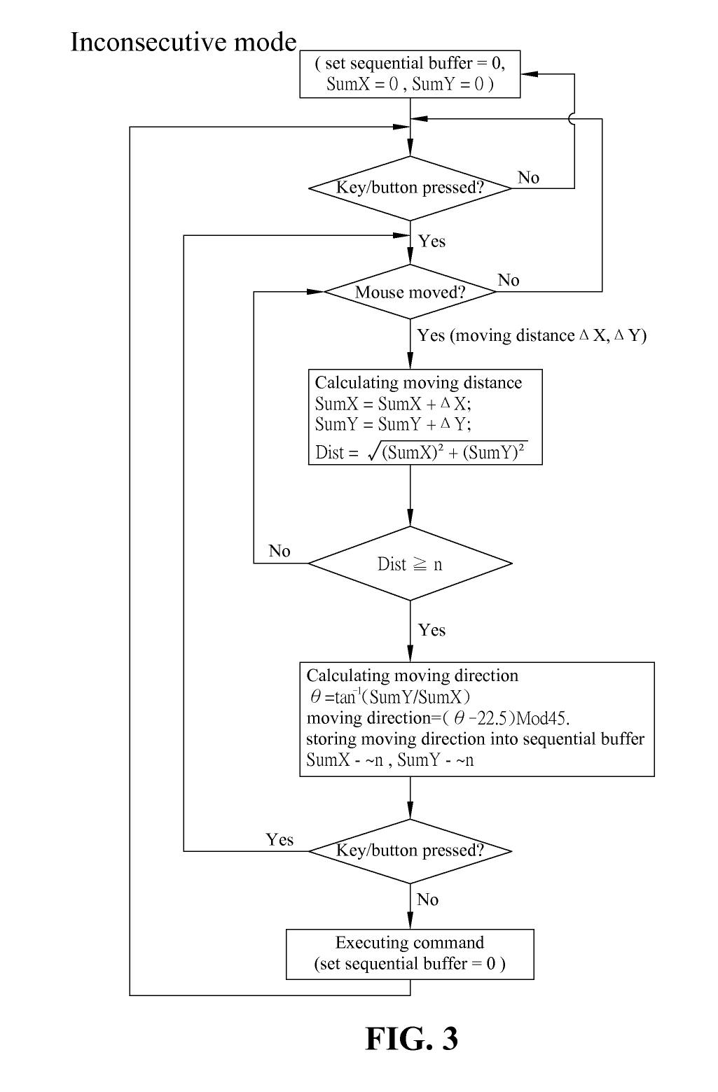

FIG. 2 is a flow chart showing a consecutive operation mode according to a first embodiment of the present invention, and FIG. 3 is a flow chart showing an inconsecutive operation mode according to a second embodiment of the present invention. Based on the flow charts shown in FIGS. 2 and 3, a mouse gesture program can be coded for recognizing the mouse gestures and performing the steps described by the present invention. The method for executing a command associated with a mouse gesture according to the present invention is performed by a gesture operation system. The gesture operation system includes a triggering module and a program module having the mouse gesture program. The program module may be installed in a mouse or a computer. When the program module is installed in the mouse, the mouse becomes an apparatus having mouse gesture function. The user may call the mouse gesture program via activating the triggering module, such as pressing a function key in a keyboard or a function button of the mouse. The triggering module can be a predetermined button of the mouse, a predetermined key of the keyboard, a plurality of predetermined buttons, a plurality of predetermined keys, or a combination of at least one predetermined button and one predetermined key.

The mouse gesture program includes a user-set-up function. The user-set-up function allows the user to associate commands with the mouse gestures. The user-set-up function allows the user to set up the triggering module. The user-set-up function also allows the user to associate the triggering module with the consecutive operation mode or the inconsecutive operation mode. The consecutive operation mode executes the command right after recognizing the mouse gesture and consecutively repeats this process of recognizing-and-executing. The inconsecutive operation mode does not execute commands until all of the mouse gestures are recognized. The user-set-up function further allows the user to set function types of the buttons. That is, if pressing different buttons with the same mouse gesture, the mouse gesture program will execute different commands corresponding to the different buttons. For example, a rightward mouse gesture with a “Shift” key will go to a next page of a web browser, a rightward mouse gesture with an “Alt” key will go to a next two page of a web browser, and a rightward mouse gesture with the “Alt” key and the “Shift” key will go to a next three page of a web browser. The user-set-up function allows the user to set a displacement (distance) of the mouse gesture. When the triggering module is set for the consecutive operation mode and the displacement is set to be relative short, the user can quickly, conveniently and consecutively execute the corresponding commands. For example, the user sets the mouse motion track in the 45° region associated with a zooming-in command, pressing a right button of the mouse associated with the consecutive operation mode, and the displacement of the mouse gesture. When the user presses the right button of the mouse and drags the mouse toward the upper right direction, the mouse gesture program executes the zooming-in command once or consecutively executes the zooming-in command several times depending on how long the preset displacement and the mouse gesture are.

According to the present invention, it can be set that, if a predetermined button of the mouse is pressed, the mouse gesture program starts to recognize the mouse gesture. When the mouse gesture is recognized, the mouse gesture program executes a command corresponding to the mouse gesture. In the zooming-in execution mentioned above, the mouse gesture program executes a command which is equivalent to pressing a “Ctrl” key of the keyboard and scrolling forward a scroll wheel of the mouse. Therefore, the picture is zoomed in. The present invention may further provide a user-set-up interface, which allows the user to conveniently set the keys, the buttons, the mouse gestures and the corresponding commands. The user can easily define a multimedia key, a word processing key, file processing combination keys, document editing combination keys, a web browsing key, or combinations of predetermined buttons of the mouse and predetermined keys of the keyboard. Thus, the user can conveniently drag the mouse so as to promptly execute the corresponding predetermined command. The motion tracks can be displayed on a monitor to show how the mouse gesture is recognized. After the mouse gesture is recognized and the corresponding command is executed, the motion track is cleared off from the monitor. In the zooming-in execution mentioned above, when the user drags the mouse, the mouse motion track having an angle of 45° appears on the monitor. The mouse motion track extends as the mouse is dragged. When a length of the mouse motion track reaches the preset displacement, the zooming-in command is executed and the motion track is cleared off from the monitor. If the user keeps dragging the mouse, the aforementioned steps are repeated until the user releases the right button of the mouse.

The following embodiment is a consecutive operation mode. A mouse gesture according to a first embodiment of the present invention is set to consecutively zoom in a picture. The mouse gesture includes a predetermined displacement of 20 pixels and an angle of 45°. When a user uses graphics software and tries to zoom in a picture, the user presses down a right button of a mouse to start a triggering module, and then drags the mouse toward an upper right direction. A mouse motion track having an angle of 45° is shown on a monitor. The mouse motion track extends as the mouse is dragged. When a distance of the mouse motion track reaches 20 pixels, a command that is equivalent to a “Ctrl” key of a keyboard and scrolling forward a scroll wheel of the mouse is executed for one time. The picture is zoomed in once. If the user keeps dragging the mouse for another 40 pixels in the same direction and then releases the right button, the command is further executed twice. That is, the picture is zoomed in the second time when the mouse motion track reaches the second 20 pixels, and the picture is zoomed in the third time when the mouse motion track reaches the third 20 pixels. When the right button is released, the mouse gesture ends.

FIG. 4 is a schematic diagram illustrating that the mouse motion track is a single line. The single line may include two lines going forth and back. The user can set a preference value of the predetermined displacement, and therefore the command corresponding to the mouse gesture can be consecutively executed. The corresponding commands may include consecutively going forward or backward a page of a web browser, consecutively zooming in or zooming out a picture, consecutively opening or closing an application program, consecutively increasing or decreasing a volume of a speaker, etc.

The following embodiment is an inconsecutive operation mode. A mouse gesture according to a second embodiment of the present invention is set to run a computer program, such as open a music player, and execute a certain function of the program, such as play music. Referring to FIG. 5, the mouse gesture includes two connection lines sequentially connected together. The user can set the commands associated with the connection lines, respectively. For example, the user sets clicking the right button of the mouse as starting the triggering module, dragging the mouse leftward (an angle of 180°) corresponding to a command of opening the music player, and dragging the mouse upward (an angle of 90°) corresponding to a command of playing the music. When the user tries to open the music player and play the music, the user holds down the right button of the mouse, drags the mouse leftward and then upward, and then releases the right button. When the leftward mouse motion track reaches a first predetermined displacement, a number 4 (180°=4×45°, N=4) is stored into a sequential buffer and the first predetermined displacement is subtracted from the mouse motion track. When the upward mouse motion track reaches a second predetermined displacement, a number 2 (90°=2×45°, N=2) is stored into the sequential buffer and the second predetermined displacement is subtracted from the mouse motion track. When the right button of the mouse is released, the commands respectively corresponding to the numbers 4 and 2 stored in the sequential buffer are executed. Thus, the music player program is opened and the music is played.

FIG. 6 is a schematic diagram illustrating that the mouse motion track is composed of three connection lines sequentially connected together. The mouse motion track is composed of a first connection line, a second connection line, and a third connection line connected in sequence. Each of the first connection line, the second connection line, and the third connection line includes a start point and an end point. The end point of the third connection line represents a finish point of the mouse motion track, and the start point of the first connection line represents a beginning point of the mouse motion track. The three connection lines of the mouse motion track may be set to associate with three commands, respectively. The principle of the mouse gesture having three connection lines is the same as the mouse gesture having two connection lines, and therefore is not repeated hereby.

Although the present invention has been described with reference to the preferred embodiments thereof, it is apparent to those skilled in the art that a variety of modifications and changes may be made without departing from the scope of the present invention which is intended to be defined by the appended claims. For example, shapes, contents and configurations of the mouse gestures can be adaptively modified; a key or a combination of keys to start a triggering module can be varied by further introducing SHIFT, CTRL, ALT keys; or on and off of the trigger module is notified by marks on the monitor or sound from the speakers.

What is claimed is:

1. A method for executing a command associated with a mouse gesture by a gesture operation system, the gesture operation system comprising a mouse, the method comprising the steps of:
(1) recording a motion track of the mouse;
(2) calculating a distance of the motion track of the mouse; if the distance is less than a predetermined value, returning to step (1);
(3) transforming the motion track from rectangular coordinates to polar coordinates represented by the distance and an angle, in which the polar coordinate system is divided into eight angle regions, determining which angle region the angle of the polar coordinates is located in, and executing the predetermined command corresponding to the angle region in which the angle is located; wherein the eight angle regions are defined as N×45°±22.5°, and N is one of integers 0, 1, 2, 3, 4, 5, 6, and 7; and
(4) clearing the recorded motion track or subtracting the predetermined value from the recorded motion track, and returning to step (1).

2. The method as claimed in claim 1, wherein the steps (1)-(4) are started or stopped by pressing a predetermined button of the mouse.

3. The method as claimed in claim 1, wherein the steps (1)-(4) are performed in one of the mouse and a computer.

4. The method as claimed in claim 1, wherein the motion track is a single line comprising a start point and an end point, and the single line has the angle which is regarded as an integral multiple of 45°.

5. The method as claimed in claim 1, wherein the motion track is composed of at least two connection lines sequentially connected together, each of the connection lines comprises a start point and an end point, the end point of the former connection line is overlapped with the start point of the latter connection line connected thereto, the start point of the first connection line is a beginning point of the motion track and the end point of the last connection line is a finish point of the motion track, and each of the connection lines has an angle which is regarded as an integral multiple of 45°.

6. The method as claimed in claim 4, wherein the single line comprises two lines going forth and back.

7. The method as claimed in claim 4, wherein the single line has a length determined by a variable predetermined value.

8. The method as claimed in claim 5, wherein the connection line comprises two lines going forth and back.

9. The method as claimed in claim 5, wherein each of the connection lines has a length determined by a variable predetermined value.

10. A method for executing a command associated with a mouse gesture by a gesture operation system, the gesture operation system comprising a triggering module and a program module, the method comprising the steps of:
(1) if a predetermined button of the triggering module is pressed down, performing steps (2) through (4) in the program module; otherwise going to step (5);
(2) recording a motion track of a mouse in the program module;
(3) calculating a distance of the motion track of the mouse in the program module; if the distance is less than a predetermined value, returning to step (1);
(4) transforming the motion track from rectangular coordinates to polar coordinates represented by a distance and an angle, in which the polar coordinate system is divided into eight angle regions, determining which angle region the angle of the polar coordinates is located in, storing a number representing the angle region in which the angle is located into a sequential buffer, subtracting the predetermined value from the recorded motion track, and returning to step (1) in the program module; wherein the eight regions are defined as N×45°±22.5°, and N is one of integers 0, 1, 2, 3, 4, 5, 6, and 7;
(5) executing the corresponding predetermined commands according to a content of the sequential buffer in the program module; and
(6) clearing the recorded motion track and sequential buffer, and returning to step (1) in the program module.

11. The method as claimed in claimed 10, wherein the triggering module is installed in the mouse.

12. The method as claimed in claimed 10, wherein the program module is installed in one of the mouse and a computer.

13. The method as claimed in claim 10, wherein the motion track is a single line comprising a start point and an end point, and the single line has the angle which is regarded as an integral multiple of 45°.

14. The method as claimed in claim 10, wherein the motion track is composed of at least two connection lines sequentially connected together, each of the connection lines comprises a start point and an end point, the end point of the former connection line is overlapped with the start point of the latter connection line connected thereto, the start point of the first connection line is a beginning point of the motion track and the end point of the last connection line is a finish point of the motion track, and each of the connection lines has an angle which is regarded as an integral multiple of 45°.

15. The method as claimed in claim 13, wherein the single line comprises two lines going forth and back.

16. The method as claimed in claim 13, wherein the single line has a length determined by a variable predetermined value.

17. The method as claimed in claim 14, wherein the connection line comprises two lines going forth and back.

18. The method as claimed in claim 14, wherein each of the connection lines has a length determined by a variable predetermined value.
